(19) United States
(12) Patent Application Publication
(10) Pub. No.: US 2010/0208903 A1
(43) Pub. Date: Aug. 19, 2010

(54) AUDIO MODULE FOR THE ACOUSTIC MONITORING OF A SURVEILLANCE REGION, SURVEILLANCE SYSTEM FOR THE SURVEILLANCE REGION, METHOD FOR GENERATING A SOUND ENVIRONMENT, AND COMPUTER PROGRAM

(75) Inventor: Stephan Heigl, Nuernberg (DE)

Correspondence Address: MICHAEL J. STRIKER, 103 EAST NECK ROAD, HUNTINGTON, NY, 11743, US

(73) Assignee: ROBERT BOSCH GMBH, Stuttgart (DE)

(21) Appl. No.: 12/670,447

(22) PCT Filed: Sep. 12, 2008
(86) PCT No.: PCT/EP08/62133

§ 371 Date: Jan. 25, 2010

(30) Foreign Application Priority Data
Oct. 31, 2007 (DE) 10 2007 052 154.7

(51) Int. Cl. H04R 29/00

(52) U.S. Cl. 381/58

(57) ABSTRACT

The invention relates to an audio module 4 for the acoustic monitoring of a monitoring region 2, wherein a plurality of microphones 3 is disposed in the monitoring region 2, having a memory device 16 for storing a model 17 of the monitoring region and positional information of the microphones 3, having an audio input interface 5 in the input of audio input signals of the microphones 3, having an audio input interface 9 for the output of an audio output signal, which is configured for actuating an audio output device 12 for a listener 14, and having a positional input interface 6 for the input of a tapping position in the monitoring region 2 and by means of a processing unit 18 that is configured to determine the audio output signal on the basis of the input tapping position 7, the model 17, and the audio input signals such that the listener 14 is virtually displaced into the tapping position.

### BACKGROUND INFORMATION

The present invention relates to an audio module for the acoustic monitoring of a surveillance region, in which a plurality of microphones is located in the surveillance region, including a storage device for storing a model of the surveillance region and positional information on the microphones, and including an audio input interface for the input of audio input signals from the microphones, and including an audio output interface for the output of an audio output signal designed to activate an audio output device for a listener. The present invention likewise relates to a surveillance system that includes an audio module of this type, a method for generating a sound environment, and a related computer program.

Surveillance systems are typically used to monitor, e.g., public spaces, intersections, streets, commercial buildings, in particular prisons, hospitals, libraries, parking garages, or private buildings using sensors. Video cameras are preferably used as sensors, and the streams of image data recorded by the video cameras distributed throughout a region are usually supplied to a monitoring center, where they are evaluated by surveillance personnel or in an automated manner. In addition to the surveillance cameras, microphones are often likewise distributed throughout the surveillance regions in order to obtain optical and acoustic information.

Surveillance systems of this type are complex in design and often also include any type of model of the surveillance region including the sensors installed therein, in particular the cameras and microphones. WO 2007/095994 makes known a surveillance system of this type, for example. These surveillance systems are the closest prior art.

### DISCLOSURE OF THE INVENTION

The following are disclosed within the scope of the present invention: an audio module which, in particular, is part of a surveillance system of this type and has the features of claim 1, a surveillance system including the audio module and having the features of claim 9, a method for generating a sound environment and having the features of claim 11, and a computer program for implementing the method and having the features of claim 12.

Preferred or advantageous embodiments of the present invention result from the dependent claims, the description that follows, and the attached figures.

The audio module according to the present invention is used to implement acoustic monitoring in a surveillance region which represents the region that exists in reality, e.g., in the form of a plurality of rooms, streets, factory buildings, corridors, etc.

A plurality of microphones is distributed, in particular, throughout the surveillance region, in order to pick up acoustic information. The microphones are preferably distributed such that their detection regions overlap, in particular such that at least 60%, preferably at least 80%, and in particular at least 90% of the flat surveillance region is covered via detection regions that overlap in an at least two-fold manner.

The audio module includes a storage device for the temporary or permanent storage of a model of the surveillance region and positional information on the microphones. It may be provided, in particular, that the aforementioned data are loaded into the audio module during operation. The positional information on the microphones preferably includes information regarding their location in the surveillance region, thereby making it possible to depict the microphones in the model, and information regarding the orientation of the microphones. Optionally, technical information on the microphones, e.g., directional characteristics, amplification, damping, etc., is contained in the storage device.

The audio module includes an audio input interface for the input or receipt of audio input signals from the microphones. The audio input interface may be directly connected to the microphones, e.g., via cables or wirelessly, or the audio input interface receives the audio input signals from the microphones via an intermediate storage device.

The audio module includes an audio output interface for the output of an audio output signal which is designed to activate an audio output device for a listener. The audio input interface and the audio output interface may process analog and/or digital signals.

The audio module is preferably designed to perform real-time processing of the audio input signals, in a manner that includes a delay between the input of the audio input signals and the output of the audio output signals of less than 10 s, preferably less than 5 s, and in particular less than 1 s. As an alternative or in addition thereto, the audio module may be used to subsequently evaluate the audio input signals, and so the evaluation is time-delayed, and is performed in particular at any point in time or off-line.

Within the scope of the present invention it is provided that the audio module includes a position input interface for the input of a listening position in the surveillance region, thereby enabling the listener to transmit a desired listening position to the audio module. Furthermore, the audio module includes a processing unit which determines—in particular calculates or mixes—the audio output signal on the basis of the listening position that was input, the model, and the audio input signals in such a manner that the listener is virtually relocated to the listening position.

In other words, the processing unit is designed to generate an audio output signal that activates the audio output device in such a manner that a sound environment, in particular stereophonic sound and/or spacial sound, including positional and/or directional information is output to the listener depending on the listening position. As an alternative or in addition thereto, the processing unit is designed to generate an artificial sound environment in a listening environment that simulates the real sound environment at the listening position.

The present invention is based on the idea of virtually relocating the listener to the listening position using the audio module, thereby enabling the listener to listen in a “location-independent” manner. For example, if the listener is virtually relocated to a listening position in a room, the listener may determine, on the basis of the audio output signal that is output, whether a source of noise is located to his left or right, in front of him or behind him, or even above him or below him, relative to his (virtual) listening position. The listener is thereby enabled, e.g., to locate a source of noise or even to follow it in a virtual manner by virtue of the fact that the listener changes his listening position such that he “follows” the source of the noise. In this manner, it is even made possible for surveillance personnel to locate sources of noise that are hidden and may therefore not be perceived optically, e.g., a ticking sound in a suitcase, a source of noise in a cabinet, etc.

In a preferred embodiment, the listening position includes a location position and a directional position. In this manner, the listener is capable of relocating to the desired listening position, and of defining a desired listening direction, thereby ensuring that the virtual listening environment is depicted with the correct position as desired. Optionally, the audio module includes calibration means for calibrating the audio module and/or the audio output device, thereby making it possible to orient the virtual sound environment generated by the audio output device in a correct position relative to the listening position in the real surveillance region.

In a preferred development of the present invention, the audio module and/or the processing unit are/is designed such that the listening position is freely selectable in the model, in particular in a section of the model equipped with a microphone. The listener is therefore enabled to virtually relocate himself to any—in particular to any monitored—listening position in the model and/or surveillance region. In particular, the listening position is freely selectable independent of a specific microphone position and/or camera position. It is preferably provided that the audio output signals are formed via the weighted mixing of audio signals from at least two or more microphones that cover the selected listening position via their detection range, in which case the weighting is dependent on the relative position of the listening position and the positional information on the relevant microphones.

In a preferred realization of the present invention, the model is designed as a 2D or 3D model. In the case of a 2D model, the listener moves virtually, e.g., through an outline of a building or the like. In a 3D model, the listener may also change his vertical position; in particular, the listener may move between floors of a building, or change his vertical position in a room.

In an advantageous development of the present invention, the model includes a sound collision model, in which sound-absorbing, sound-reflecting, sound-deflecting, and/or sound-attenuating objects are detected. Object of this type are designed, e.g., as walls, in particular building walls or partitions, or as sound-relevant objects such as room dividers, cabinets, or the like. Via the supportive use of a sound-collision model, it is possible to better simulate the virtual sound environment of the real sound environment at the listening position, since sound-altering properties of the environment are taken into consideration.

In a practical application of the present invention, the audio module includes a human-machine interface (HMI) which is connected to the position input interface via signals, and which makes it possible to shift the listening position in the model in a stepless or closely-stepped manner. For example, the human-machine interface is designed as a computer mouse, a pointer, a touchpad, or the like.

In order to further improve the ease of use of the audio module, the audio module is preferably programmed and/or electronically configured to depict the model and the listening position on a display device, e.g., in the sense of a virtual reality. Optionally, the virtual reality is supplemented with real, in particular current, camera images from the surveillance region.

The audio output device is preferably designed as a stereophonic and/or spacial sound output device in order to configure the stereophonic sound and/or spacial sound of the virtual sound environment to be information-rich. In particular, the audio output device may be realized as a multiple-channel sound system, e.g., as Surround-Sound 5.1, Quadrofonie, Dolby Surround, Dolby Surround Pro Logic, Dolby Digital, DTS, SDDS, IMAX, Fantasia, MUSE-Laserdisc, or the like.

In summary, the present invention also relates to an audio module designed for use in a surveillance system, in the case of which microphones are positioned in a surveillance region, the surveillance region and the microphones are modeled in a model, and a virtual sound environment is generated in a processing unit which is preferably designed as a software system or as software components for the real-time calculation of 3D audio, and which has access to the audio data of the microphones and the model. For this purpose, sources of sound are modeled in the audio module using the audio module and on the basis of the positions of the microphones, and the sound sources are fed with the associated microphone audio data streams. By defining the listening position, the user of the system determines which listening position to listen from. The audio module generates an artificial audio output signal for the selected listening position. The advantage of the audio module is that the listener may listen to recordings from a plurality of surveillance microphones simultaneously, assign them to locations, and relate them to one another.

A further subject matter of the present invention relates to a surveillance system for a surveillance region that includes an audio module of the type described above, and/or as described according to one of the preceding claims. The surveillance system preferably includes a plurality of surveillance cameras which are suited and/or situated to observe the surveillance region. As an alternative, the surveillance system includes a related interface for recording video data. The surveillance system is thereby enhanced to become an audio-video surveillance system.

Another subject matter of the present invention relates to a method for generating an artificial or virtual sound environment, e.g., in a monitoring center, which virtually relocates a listener to a listening position in a surveillance region, and in which the sound environment is created on the basis of a desired listening position, a model of the surveillance region, and the audio input signals from microphones located in the surveillance region. Preferably, the method is implemented using the above-described audio module and/or the above-described surveillance system.

A further subject of the present invention relates to a computer program which includes program code means having the features of claim 12.

### BRIEF DESCRIPTION OF THE DRAWINGS

Further features, advantages, and effects of the present invention result from the following description of a preferred embodiment of the present invention.

FIG. 1 shows a schematic block diagram of a surveillance system that includes an audio module, as an embodiment of the present invention.

### EMBODIMENT(S) OF THE INVENTION

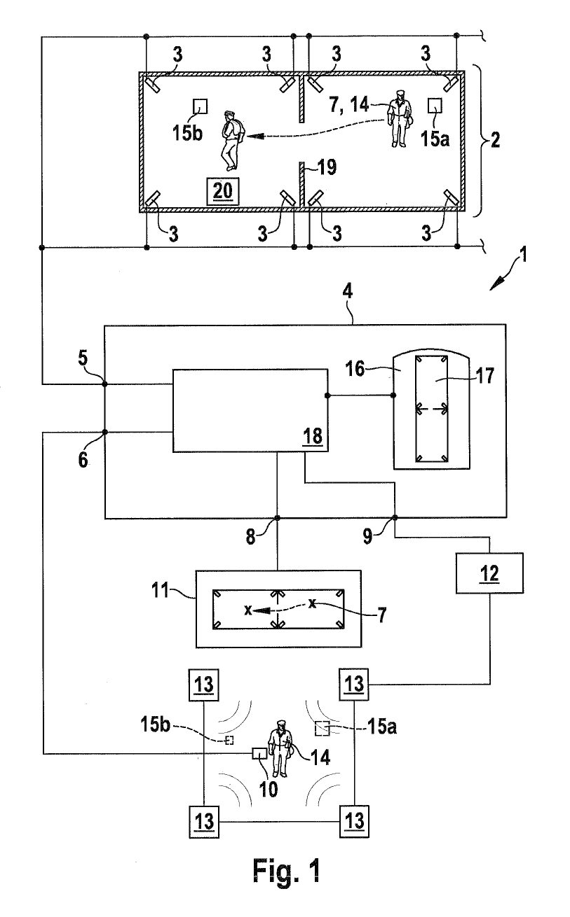

FIG. 1 shows a schematic block diagram of a surveillance system 1 as an embodiment of the present invention, which is designed and/or situated to acoustically monitor a surveillance region 2.

In the embodiment shown in FIG. 1, surveillance region 2 is designed as two rooms; in alternative embodiments it may have any type of design and, in particular, may include a plurality of vertically-arranged levels, or floors. A plurality of surveillance microphones 3 is distributed throughout surveillance region 2, and preferably such that their acoustic surveillance regions overlap or at least overlap in sections.

Surveillance system 1 includes an audio module 4 which is connected via an audio input interface 5 to surveillance microphones 3 via signals. Furthermore, audio module 4 includes a position input interface 6 for the input of a listening position 7, the function of which is explained in greater detail below, and includes a video output interface 8 and an audio output interface 9.

Position input interface 6 is connected via signals to a human-machine interface (HMI) 10 which is designed, e.g., as a computer mouse, joystick, etc. Video output interface 8 is used to transfer a video signal to a display device 11, e.g., a monitor. Audio output interface 9 is connected via signals to an audio output device 12 which is designed to activate loudspeaker 13 on the basis of the audio output signals which are transmitted from audio output interface 9 to audio output device 12. In particular, audio output device 12 is designed as a stereophonic sound system that activates loudspeaker 13 in a manner such that a listener 14 is relocated to a sound environment, in which case the audio information that is output contains positional and/or directional information, in particular 3D directional information.

In terms of function, surveillance system 1 is designed as audio module 4 in particular, thereby enabling listener 14 to freely select a listening position 7 within surveillance region 2 using HMI 10, e.g., using display device 11. On the basis of the selection of listening position 7, the input audio signals from microphone 3 are processed by audio module 4 such that audio output signals are output to audio output device 12, thereby enabling loudspeaker 13 to generate a virtual sound environment that simulates the real sound environment in surveillance region 2 at listening position 7. Listener 14 is shown standing at listening position 7 in surveillance region 2, for purposes of graphic illustration.

Using surveillance system 1, listener 14 may determine, on the basis of his listening position 7 at that moment, e.g., whether a relevant audio signal is coming from a possible sound source 15a on his right, or from a possible sound source 15b on his left, in the next room. In FIG. 1, for purposes of visualization, sound sources 15 a, b are depicted once more, using dashed lines, in the virtual sound environment generated by loudspeakers 13, in order to illustrate their virtual “sound source” position. In addition, sound source 15b is shown reduced in size, in order to graphically emphasize that it is reproduced in a damped manner relative to sound source 15a due to the larger distance between listening position 7 and the position of sound source 15b, and due to the shield created by the door passage region.

For the case in which listener 14 determines that the audio signal is coming from sound source 15b, he may move virtually in the direction of sound source 15b using HMI 10, in order to thereby better localize sound source 15b, and to improve the audio quality. This procedure is illustrated using a dashed arrow line.

The functionality is implemented in that audio module 4 receives, as input information, listening position 7 via position input interface 6, and the audio signals from microphone 3 via audio input interface 5. In addition, audio module 4 includes a database 16 in which a model 17 of surveillance region 2 and microphones 3 located in surveillance region 2 is stored. In a processing unit 18, sound sources are modulated on the basis of the known positions of microphones 3 and, optionally, their recording characteristics in processing unit 18, and they are fed with the associated audio input signals. In particular, processing unit 18 is designed to generate a 3D sound environment using signals. Depending on listening position 7, the sound environment that is generated is then shifted or rotated, and it is output via audio output interface 9 to audio output device 12, thereby enabling audio output device 12 to output the virtual sound environment via loudspeakers 13 to listener 14 in a manner that is correct in terms of position and that correctly reflects the selection of listening position 7.

To further improve the audio quality of the sound environment that is output, database 16 optionally includes information on the collision objects in surveillance environment 2. Collision objects of this type are designed, e.g., as partitions 19 or large interference objects 20. Collision objects 19, 20 of this type are taken into account in the modeling of the noise sources, thereby making it possible to also reproduce the attenuations, amplifications, or reflectances of sound saves in surveillance region 2 in a realistic manner.

Surveillance system 1 therefore provides listener 14 with the advantage that he may move in a virtual manner to any position, in particular independently of a single microphone position or an individual camera position, and to investigate the real sound environment there, independently of his location.

What is claimed is:

1. An audio module (4) for the acoustic monitoring of a surveillance region (2), in which a plurality of microphones (3) is located in the surveillance region (2),
comprising a storage device (16) for storing a model (17) of the surveillance region and positional information on the microphones (3),
comprising an audio input interface (5) for the input of audio input signals from the microphones (3),
comprising an audio output interface (9) for the output of an audio output signal designed to activate an audio output device (12) for a listener (14),
characterized by
a position input interface (6) for the input of a listening position in the surveillance region (2), and by a processing unit (18) which is designed to determine the audio output signal on the basis of the listening position (7) that was input, the model (17), and the audio input signals such that the listener (14) is virtually relocated to the listening position.

2. The audio module (4) as recited in claim 1,
wherein
the listening position (7) includes a location position and a directional position.

3. The audio module (4) as recited in claim 1,
wherein
the listening position (7) is freely selectable in the model (17) and/or in a microphone-equipped section of the model (17) or the surveillance region (2), and/or independently of a microphone position and/or a camera position.

4. The audio module (4) as recited in claim 1,
wherein
the model (17) is designed as a 2D and/or 3D model.

5. The audio module (4) as recited in claim 1,
wherein
the model (17) includes a sound collision model in which sound-altering, in particular sound-absorbing, sound-reflecting, sound-deflecting, and/or sound-attenuating objects (19, 20) are detected.

6. The audio module (4) as recited in claim 1,
characterized by
a human-machine interface (10) which is connected to the position input interface (6) via signals, and which makes it possible to steplessly shift the listening position (7) in the model (16) and/or in the surveillance region (2).

7. The audio module (4) as recited in claim 1, characterized by a display device (11), in which the audio module (4) is programmed and/or electronically configured to depict the model (17) and the listening position (7) on the display device.

8. The audio module (4) as recited in claim 1, characterized by the audio output device (12) which is designed as a stereophonic and/or spacial sound output device.

9. A surveillance system (1) for a surveillance region (2), characterized by an audio module (4) as recited in claim 1.

10. The surveillance system (1) as recited in claim 9, characterized by a plurality of surveillance cameras which are suited and/or situated to observe the surveillance region (2).

11. A method for generating a sound environment, e.g., in a monitoring center which virtually relocates a listener (14) to a listening position (7) in a surveillance region (2); the sound environment is created on the basis of a desired listening position (7), a model (17) of the surveillance region and the audio input signals from microphones (3) located in the surveillance region (2).

12. A computer program comprising program code means for carrying out all steps of the method as recited in claim 11 when the program is run on a computer and/or a device (1, 4).
